(19) United States
(12) Patent Application Publication
(10) Pub. No.: US 2021/0264401 A1
(43) Pub. Date: Aug. 26, 2021

(54) OWNERSHIP OF A MARKED ITEM OUTSIDE A SHOP

(71) Applicant: KEZZLER AS, OSLO (NO)

(72) Inventor: MAGNAR LØKEN, OSLO (NO)

(73) Assignee: KEZZLER AS, OSLO (NO)

(21) Appl. No.: 17/184,819

(22) Filed: Feb. 25, 2021

(30) Foreign Application Priority Data
Feb. 26, 2020 (NO) 20200235

(51) Int. Cl. G06Q 20/20; G06K 19/06

(52) U.S. Cl. CPC G06Q 20/208; G06K 19/0615

(57) ABSTRACT

A code attribution control system includes unique codes. Each of the codes is arranged or marked openly accessible legible or scannable on a sales item. One or more of the sales item is openly and freely displayed and for sale within a physical border of in a physical shop. The item initially is allocated a status code attribute as “not sold” in said attribution control system. For a consumer to establish ownership or indication of ownership of the item, the consumer scans and registers the code outside the border of the shop, whereby the status code attribute is changed to “sold” in the attribution control system, after which owner restricted services related to the item will be made available to the consumer.

### INTRODUCTION

The present invention is a code attribution activation system for unique codes of sales items. The codes are arranged as legible codes on items in a shop. The code itself may be legible for the potential buyer in the shop.

### Introduction and Problem

For an item (10) with a code (30) in a shop or other publicly accessible sales location, the code (30) carries potential services and benefits, wherein said benefits are unlocked by the code itself. These services and benefits should only be available to the owner. A problem solved by the current invention is that when an item that is freely displayed within a physical shop, and the code on the item is possible to scan in the shop shelf or in a shop storage area , the consumer can simply scan the code and get access to the services and benefits that only should be available after proof of purchase or otherwise indication of ownership. If such undesired scanning can take place, the subsequent proper owner would be denied his appropriate services and benefits. Unless this undesired scanning is controlled and managed, in a physical shop, the scanning of codes is hard to avoid.

Examples of such services and benefits may be given by the following, reserved for the actual owner:
discount coupon codes for being used for additional purchases, or purchases of multiple units, or giving access to other services.
a guarantee certificate for the bought item,
accessing user instructions for the bought item,
participation in general loyalty schemes and programs, and the like.

A common practice has been to place a unique code as a label or print directly on the product package's surface and legible for all. A person who uses the code, e.g. for identifying a discount coupon code, without actually buying the product, actually steals the discount. He may then, when being inside the shop, enter the code, e.g. on an interactive internet page, for abusing the discount coupon code thus obtaining a discount on other goods from the same manufacturer or the same shop. One practical way for the manufacturer of the product is to place the code inside the product packaging, in the form of an internally placed label tag, or an internal print at the rear of the carton, but this requires at least one more labeling and packaging step, and adds undesired cost.

### Solution to the Problem

The present invention is defined in the attached claims, and presents a solution to one or more of the stated problems.

### Advantages of the Invention

A first advantage of the invention is that one avoids codes and benefits being abused by non-owners in the shop, when the code is openly marked on the product. A solution could be to protect and hide the code out of view, by e.g. scratch-panels, double layering, or inside packaged labels. It is not uncommon for consumers in a shop to tamper with such hidden codes by destroying the code protection, the container, without being owners, and by such making the product non-sellable. The invention conserves brand integrity and package integrity. Due to the fact that a value is linked to the item by the code, this creates a temptation and an opportunity for some persons to tamper with the product's integrity.

A second advantage of the invention related to the first, the cost of protecting the code on the item from tampering is very high, and in practical terms, inhibitive in a price-sensitive market. Marking items with directly legible codes, that may also be used for providing services and benefits restricted to the actual owner of the product, is cost saving and serves the interest of the proper owner. One way of protecting the value and the code, if the code is freely presented inside the shop border (22), is to provide the consumer with some type of proof of purchase in the shop itself that releases the value (other services and benefits) to the now registered owner. In this case some kind of system operated by the ship, an electronic cash register, typically, would have to be interacted by both the ship and then by the consumer to register the ownership based on the unique code of the item. However it is evident that tils is a rather cumbersome and expensive method that would incur undesired scans, so in practice this is less feasible.

So a third advantage by the present invention, considering the above, is that it will be possible and easy to have freely and open codes on items in the shop that carry owner restricted services and benefits, without the need for having registering the ownership by the shop or shop operator to control and avoid undesired code scans and abuse of those.

In other words, the present invention makes it possible to freely present open codes in the shop area as described above, for the purpose of conveying owner services and benefits, without the need for systems for proof of purchase within the shop or an electronic cash register, and assignment of ownership as described above, such as a system for administration or intervention or interaction within the shop area or by the shop assistants.

A fourth advantage of the present invention is that due to the fact that the unique codes are arranged for being freely displayed on the items, and not for being hidden out of direct sight in any way, the unique code may still be scanned in the shop by non-owners for both general and item specific information, such as price, requirements for use, recommended accompanying products, etc. This would not be feasible if the code was hidden.

It is important to note related to the above, that this requires unique codes on the items, as this is not possible with general codes such as GTIN (which contains a serial number up to six, and starts recounting after 999999), batch numbers, or similar. The uniqueness of the code, when scanning in the shop within the shop border (22) as a non-owner, might be used to inform about such item related information as recall status that is definitely related to an individual item. This important service and feature is not possible if the unique code is hidden and not accessible without unallowed tampering on the product. With serialization, only parts of a batch might be recalled, whereby the need to identify on an individual basis arises. Another situation is where the shop operator (or brand owner) allows the consumer freely to see some selected track and trace information, being unique for each item, without being the owner of the item. A comprehensive or complete track and trace record display might be reserved for the owner of the item.

### BRIEF FIGURE CAPTIONS The invention is illustrated in the attached drawing figures, wherein

FIG. 1 is an overview of the basic features related to the invention, but also an illustration of the invention, which will be described under the paragraph “Embodiments of the invention”, below. In FIG. 1 we have illustrated an outline plan of a shop (20) such as a building, with walls representing a border (22), and having an entry (23) and an exit (24). Items (10) are displayed for sale within the border (22). The border (22) defines an enveloping control area wherein there is an inside and an outside that are distinguished. The geometrical, geographical shape and arrangement of the border (22) is according to the discretion of the implementing party. Several such enveloping control areas may be controlled. Each item (10) is identified by a code. One or more portable/handheld units (60) with a code scanner (40) are available to the customers for scanning reading the code marks on the items (10). Usually, when a consumer purchases an item (10) when located within the border (22) of the shop (20), he will normally receive a printed receipt at the cash register (75). Alternatively, when a consumer purchases an item (10) when located within the border (22) of the shop (20), he may also receive an electronic receipt if the consumer is registered in a consumer database (50) operated by the shop and operated e.g. in an app. A basic feature of the present invention is to consider the holder of the coded item (10) outside the border of the shop, as the proprietor.

The handheld device (60) may be implemented as a mobile phone with an app dedicated to communicate with an app server (110) connected to a central data register (90) with a code attribution control system (91). The mobile phone will then under ordinary conditions be the customer's own mobile.

FIG. 2 illustrates an alternative embodiment of the invention, wherein the border (22) may be physically absent, but still defined, or divided into several connected or not interconnected sub-areas, or even “void” areas defining “outside” the border (22), such as an otherwise unrelated cafe within a shop.

### DESCRIPTION OF EMBODIMENTS OF THE INVENTION

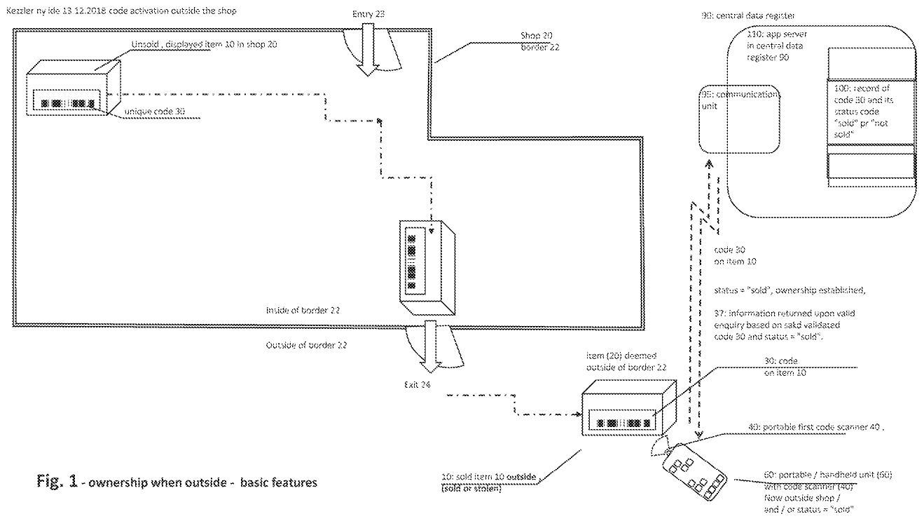

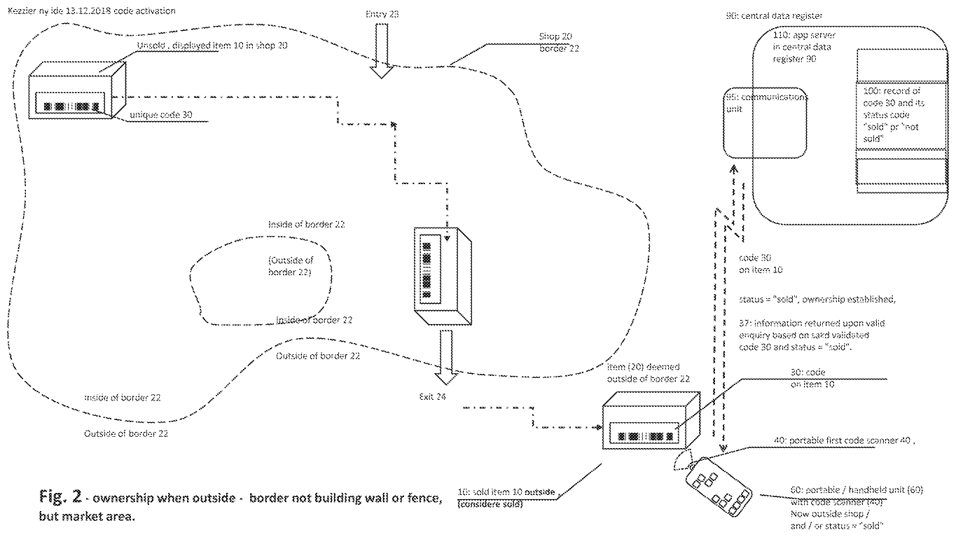

The invention is illustrated in FIGS. 1 and 2, and is code attribution control system, comprising unique codes (30). One of the purposes of the code attribution control systems is to control and manage ownership of unique coded items that can be openly and freely displayed in public shopping areas before a sales transaction, as well as when outside the shop areas whereby an owner might be assumed.

Each said code (30) is arranged or marked openly legible or scannable on a sales item (10), wherein one or more of said sales items (10) is openly and freely displayed and for sale within a physical border (22) of a physical shop (20).

Each said item (10) is initially allocated a status code (33) attribute as “not sold” in the attribution control system (91).

For a consumer to establish ownership or indication of ownership of said item (10), the consumer scans and registers said code (30) of the item (10), when he has brought the item (10) outside the border (22) of the shop (20), or is otherwise in possession of the item (10) outside the shop. When having scanned the code (30), the status code (33) attribute is changed to “sold” in the attribution control system (91),
after which owner restricted services related to the item (10) will be made available to the consumer. Those are the core features of the invention.

Thus a first condition for establishing the ownership of the item (20), is that the item (20) is actually outside the shop (20), i.e. outside the border (22) of a controlled area of the shop (20), and that the holder of the item (10) scans the code (30). (The system assumes that the holder of the item (10) is the owner, when the item (10) is outside the border (22) of the shop. Of course, the item (10) may be stolen or otherwise illegitimately obtained or brought outside the border (22), but that is legal matter not addressed here), hence the ownership in reality is indicated, such as would be the case when stolen.) The invention addresses the problem of avoiding scanning the code in the shop, when not having become the owner, to avoid wrong ownership of the item (10), and denying a non-owner services and benefits related to the ownership of the item (10).

In an embodiment of the invention, the consumer uses a portable device (60) with a code scanner (40) scanning said code (30), and the portable device (60) communicates the scanned code (30) to the attribution control system (91).

Of course, the ownership of the item (10) may be established inside the shop (20), i.e. within the border (22). The consumer and the sales item (10) may in this alternative be within the border (22) of the controlled area of the shop (20) and having registered a receipt from said shop (20) for said item (10). Thus this may be the second condition for establishing the ownership, that the consumer has a receipt, if still inside the shop.

In practice, we need to establish conditions for being outside the border (22) of the shop (20). In an embodiment of the invention, the consumer is scanning and registering the code (30) outside the border (22) when receiving a position given by a position indicating device, such as a GPS or similar, that is calculated to be outside of the control border (22). Other means to indicate a position with sufficient accuracy, which means is accepted by the shop (20) owner. Position may also be determined using other technologies, tools, or methods, such as Wifi-assisted positioning.

The shop border (22) according to invention might be a virtual or digital representation of a physical border of the shop (22). It may in an embodiment of the invention be a polygon represented by the coordinates of its corners given by the corners coordinates, or it may in yet another embodiment be a radial distance from a point representing the center of the shop or the exhibition point, to ensure a position truly outside the shop or marketplace of display.

### Position

In an embodiment of the invention, the portable device (60) is implemented as a mobile phone or a computer or similar device of some kind, with a position receiver such as a GPS, and provided with a code scanner (40) such as a mobile camera, any type of bar code code scanner, usually implemented as a camera app, or a contactless code scanner such as an RFID/near-field communication scanner.

Attribute status transfer back to owner

In an embodiment of the invention, whereafter the status code (33) attribute has been changed to “sold” in the attribution control system (91), and upon said owner restricted services related to the item (10) is made available to the consumer, the status code (33) attribute =“sold” is communicated from the attribution control system (91) to the portable device (60). The attribute =“sold” indicates successful ownership registered as “sold to consumer”, or “owned by consumer”, “owned by holder”, “bought”, or a registration number, or similar.

### Attribute Status Transfer Back to Item

In an embodiment of the invention, the attribute status is transferred straight to the item (10) instead of the owner. After the status code (33) attribute is changed to “sold” in the attribution control system (91), and upon the owner restricted services related to the item (10) are made available to the consumer, the status code (33) attribute =“sold” is communicated from the attribution control system (91), to the portable device (60), e.g. via a mobile line , and the portable device (60) communicates with the sold item (10), e.g. via a Bluetooth or Wifi line, and sends an activation code (34) activating the item (10). In another, more direct alternative, the attribution control system (91) communicates with the sold item (10) and sends an activation code (34) activating said item (10). In such an embodiment, the item (10) must be enabled for communicating with the attribution control system directly.

The term “activation code” comprises any kind of required token for enabling access of a device, or activating the device.

A practical use for the above embodiment is in cases where the item (10) is a motorized vehicle, a computer, a toy, which requires an activation code (34) to start.

In an embodiment of the invention, the consumer is registered with a personal record (52) in a consumer database (50) accessible to said attribution control system (91).

Having a value linked to a uniquely coded items is a type a variant of a reward and incentive program. It has been a common practice that in most cases it is the shop operator that has been managing such reward and incentive programs. An typical and very well known example of such is a “Buy three and get one for free”. However in some cases a program is a collaboration between the shop operator and the brand owner. These type of programs have been run with or without the use of unique item coding of the items. A new practice and new opportunity is created with the present innovation that it makes it it possible for the brand owner to alone and independently of the shop operators to offer enhanced services and benefits directly to the consumer on their own products. As in the past the brand owner, at least in practice, have been much dependent to collaborate with distributors and shop operators in order to efficiently run incentive programs. They can now avoid the need for the “middle man” when running such incentive programs because they can now operate such a incentive program, using the present innovation without the need for any shop operated systems or they labor, consent or any particular type of cooperation. Operating an item attribution system enables the brand owner to even differentiate the value the code based on the shop operator or even single shop if using a track and trace system. So if the consumer buys at the supermarket chain A, the consumer might be rewarded less than if buying a similar item at the brand owners own supermarket chain B. A track and trace system would enable to know and identify from which the sales point or shop operator in advance of the consumer scanning the item.

Further, a smaller shop operator or any operator, might be running such programs much easier if they collaborate with the brand if they decide to be the operator of the item attribution system.

An additional aspect of the present invention is, that when outside the shop border (22), the holder of the product is considered as the owner of the product, if he just scans the code and communicates with the system. The system requires that the system owner trusts that the beholder of the item is the rightful owner of the item. Theft is a calculated risk in the system, and is handled elsewhere. The invention helps conserve the brand value and value of use of the product for the product holder, and assures a simple maintenance of (for the original purchaser), or transfer of (for the used-item-buyer or inheritor in possession of of a used product) services and benefits for the product, such as updates, guarantees, spare part availability etc.,

The central data register (90) may also be connected to a customer database (50) containing records (52) about identified buyer:
name, address, gender, age, size,
income, family relations, education level, position,
contact information,
buying preferences, purchase history.

### Code Generator

In an embodiment of the invention the system comprises a code generator (120) arranged to generate two or more unique codes (30) . In an embodiment of the invention the code generator (120) may be a third party service providing said unique codes (30) on a file, physical or a data file, for marking the items (10) and for storing the unique codes (30) in the central data register (90).

### Short-Range Readable Encrypted Code Mark Label

In an embodiment of the invention, each code (30) is arranged placed on an outside surface of said sales item (10), and may be visually read, optically scanned or otherwise short-range readable. With short range readable, one must consider the code (30) is not possible to read at a distance such as from the outside of the shop (20), from the outside of said physical border (22) when within said physical border (22), if the shop (20) has a border (22). If the shop is an open market, the encrypted code (35) must not be legible from outside of the market. In practice, in an embodiment of the invention, the code (30) arranged as an encrypted text, a bar code, a QR code, or similar. (such as in an RFID).

In an embodiment of the invention, the returned information (37) related to said unique code (30), comprises the status code (33)=“sold”, or an exit key code, a transport order, a startup key code, user instructions, guarantee, sales contract, for said item (10), to said handheld device (60) and/or to another unit desired by the holder of the handheld device (60).

### Further Information 38 on Price, Number of Items

In an embodiment of the invention, some returned information (38) related to the unique code (30) may, if not status code =“sold”, still be conveyed back to the portable/handheld device (60), such as the price of the item (10), the number of corresponding items (10) available in the shop (20), either displayed or in store.

### Pay on Location

In an embodiment of the invention the handheld device (60) may then negotiate and pay for the item (10) directly or indirectly with a cash register (75) which further allows for porting the item (10) through a code scanner (70) of a cash register (75) or directly out of the shop (20) and otherwise allows the user of the handheld device (60) to the decrypted code (30), which is the purpose of it all for the user.

1. A code attribution control system, comprising unique codes,
wherein each said code is arranged or marked openly accessible legible or scannable on a sales item,
wherein one or more of said sales item is openly and freely displayed and for sale within a physical border of in a physical shop,
wherein said item initially is allocated a status code attribute as “not sold” in said attribution control system,
wherein for a consumer to establish ownership or indication of ownership of said item, the consumer scans and registers said code outside said border of the shop, and
whereby said status code attribute is changed to “sold” in said attribution control system, after which owner restricted services related to said item will be made available to the consumer.

2. The code attribution control system of claim 1, wherein the consumer uses a portable device with a code scanner scanning said code, and said portable device communicates said scanned code to said attribution control system.

3. The code attribution control system of claim 1, wherein the consumer and the sales item may alternatively be within the border of the controlled area of the shop and having registered a receipt from said shop for said item.

4. The code attribution control system of claim 1, wherein the consumer is scanning and registering the code outside when receiving a position given by a position indicating device, that is calculated to be outside of the control border.

5. The code attribution control system of claim 2 wherein said portable device a mobile phone or a computer, with a code scanner.

6. The code attribution control system of claim 2,
whereafter said status code attribute is changed to “sold” in said attribution control system, and upon said owner restricted services related to said item is made available to the consumer, said status code attribute=“sold” is communicated (indicating successful ownership registered as “sold to consumer”, or “owned by consumer”, or reg. number, or similar) from said attribution control system to said portable device.

7. The code attribution control system of claim 2,
whereafter said status code attribute is changed to “sold” in said attribution control system , and upon said owner restricted services related to said item is made available to the consumer, said status code attribute=“sold” is communicated (indicating successful ownership registered as “sold to consumer”, or “owned by consumer”, or reg. number, or similar) from said attribution control system,
to said portable device, said portable device communicating with said sold item and sending an activation code (34) activating said item, or
communicating with said sold item and sending an activation code activating said item .

8. The code attribution control system of claim 1,
wherein said consumer is registered with a personal record in a consumer database accessible to said attribution control system.

9. The code attribution control system of claim 1, wherein said shop border is a virtual representation of extension the shop, or a digital representation of a border, material or not, of the shop.

10. The code attribution control system of claim 4, wherein the position indicating device is a GPS.

11. The code attribution control system of claim 5, wherein the code scanner is a camera, any type of bar code code scanner, or a contactless code scanner, including an RFID/near-field communication scanner.

12. The code attribution control system of claim 2, wherein the consumer and the sales item may alternatively be within the border of the controlled area of the shop and having registered a receipt from said shop for said item.

13. The code attribution control system of claim 2, wherein the consumer is scanning and registering the code outside when receiving a position given by a position indicating device, that is calculated to be outside of the control border.

14. The code attribution control system of claim 3, wherein the consumer is scanning and registering the code outside when receiving a position given by a position indicating device, that is calculated to be outside of the control border.

15. The code attribution control system of claim 3 wherein said portable device is a mobile phone or a computer, with a code scanner.

16. The code attribution control system of claim 4 wherein said portable device is a mobile phone or a computer, with a code scanner.

17. The code attribution control system of claim 3,
whereafter said status code attribute is changed to “sold” in said attribution control system, and upon said owner restricted services related to said item is made available to the consumer, said status code attribute =“sold” is communicated (indicating successful ownership registered as “sold to consumer”, or “owned by consumer”, or reg. number, or similar) from said attribution control system to said portable device.

18. The code attribution control system of claim 4,
whereafter said status code attribute is changed to “sold” in said attribution control system, and upon said owner restricted services related to said item is made available to the consumer, said status code attribute =“sold” is communicated (indicating successful ownership registered as “sold to consumer”, or “owned by consumer”, or reg. number, or similar) from said attribution control system to said portable device.

19. The code attribution control system of claim 5,
whereafter said status code attribute is changed to “sold” in said attribution control system, and upon said owner restricted services related to said item is made available to the consumer, said status code attribute=“sold” is communicated (indicating successful ownership registered as “sold to consumer”, or “owned by consumer”, or reg. number, or similar) from said attribution control system to said portable device.

20. The code attribution control system of claim 3,
whereafter said status code attribute is changed to “sold” in said attribution control system, and upon said owner restricted services related to said item is made available to the consumer, said status code attribute=“sold” is communicated (indicating successful ownership registered as “sold to consumer”, or “owned by consumer”, or reg. number, or similar) from said attribution control system,
to said portable device, said portable device communicating with said sold item and sending an activation code activating said item, or
communicating with said sold item and sending an activation code activating said item.
